(19) United States
(12) Patent Application Publication
(10) Pub. No.: US 2026/0074451 A1
(43) Pub. Date: Mar. 12, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: TING ZHU, Shenzhen (CN); FU-JIN PENG, Kunshan (CN)

(21) Appl. No.: 19/324,478

(22) Filed: Sep. 10, 2025

(30) Foreign Application Priority Data
Sep. 11, 2024 (CN) 202422224523.6

(51) Int. Cl. H01R 12/71; H01R 13/24; H01R 13/41; H01R 13/50

(52) U.S. Cl. CPC H01R 12/714; H01R 13/2435; H01R 13/41; H01R 13/50

(57) ABSTRACT

An electrical connector includes: an insulating housing having opposite first and second faces and a plurality of accommodation and fixing slots; and at least one row of terminals arranged in a first direction and extending forward along a second direction, each terminal having: a base portion fixed in one of the fixing slots; a first resilient arm protruding from the first face; and a second resilient arm protruding from the second face, wherein the at least one row of terminals includes first terminals and second terminals alternately arranged, the base portions of the first terminals are inserted from the first face into corresponding fixing slots, and the base portions of the second terminals are inserted from the second face into corresponding fixing slots.

### BACKGROUND OF THE INVENTION

### Field of the Invention

The present invention relates to an electrical connector.

### Description of Related Arts

U.S. Patent Application Publication No. 2023/0411907 discloses an electrical connector comprising a plurality of terminals arranged in an array. Each horizontal row of terminals comprises signal terminals and ground terminals located on either side of each of the signal terminals. When installing the terminals, all terminals in the electrical connector are installed from top to bottom into the terminal slots, resulting in low efficiency and increased wear and tear of the plastic mold assembly.

China Patent No. 102570191 discloses an electrical connector having an insulating housing, a plurality of signal terminals inserted to the housing from a first face thereof, and a plurality of ground terminals inserted to the housing from an opposite second face thereof.

### SUMMARY OF THE INVENTION

An electrical connector comprises: an insulating housing having a first face and a second face opposite each other, and a plurality of accommodation slots and a plurality of fixing slots in fluid communication with the accommodating slots passing through the first face and the second face; and at least one row of terminals arranged in a first direction and extending forward along a second direction perpendicular to the first direction, each terminal comprising: a base portion fixed in one of the fixing slots; a first resilient arm extending from the base portion, passing through a corresponding accommodation slot, and protruding from the first face; and a second resilient arm extending from the base portion, passing through a corresponding accommodation slot, and protruding from the second face; wherein the at least one row of terminals comprises first terminals and second terminals alternately arranged, the base portions of the first terminals are inserted from the first face into corresponding fixing slots, and the base portions of the second terminals are inserted from the second face into corresponding fixing slots.

An electrical connector comprises: an insulating housing having a first face, an opposite second face, and terminal slots passing through the first face and the second face; and a plurality of terminals arranged in an array and comprising one row of ground terminals and one row of signal terminals; wherein the signal terminals and the ground terminals are alternately arranged along the first direction, each of the terminals comprises a base portion fixed in one of the terminal slots, a first resilient arm extending from the base portion and out of the first face, a second resilient arm extending from the base portion and out of the second face, and guide ribs extending from the base portion for facilitating installation of the terminal, the guide ribs of each of the signal terminals extend from the base portion toward the first face and are positioned at two sides of the first resilient arm, the guide ribs of each of the ground terminals extend from the base portion toward the second face and are positioned at two sides of the second resilient arm, and the signal terminal and the ground terminal are installed to the insulating housing through the first face and the second face.

### BRIEF DESCRIPTION OF DRAWINGS

FIG. 1 shows a perspective view of an electrical connector of the present disclosure, wherein two terminals are disassembled;

FIG. 2 shows a perspective view of the electrical connector shown in FIG. 1 from another perspective;

FIG. 3 shows a perspective view of a first terminal and a second terminal of the electrical connector shown in FIG. 1;

FIG. 4 shows a partial cross-sectional view of the connector shown in FIG. 1 along cut line A-A;

FIG. 5 shows a partial cross-sectional view of the connector shown in FIG. 1 along cut line B-B;

FIG. 6 shows a bottom view of the electrical connector shown in FIG. 1;

FIG. 7 shows an enlarged view of a portion of FIG. 6;

FIG. 8 shows a partial cross-sectional view of the electrical connector shown in FIG. 1 along cut line C-C;

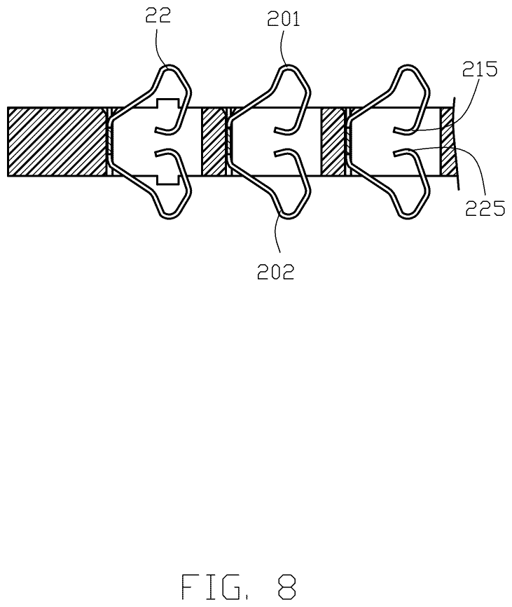

FIG. 9 shows a side view of the second terminal shown in FIG. 3; and

FIG. 10 shows a perspective view of the second terminal shown in FIG. 3 from another perspective.

### DETAILED DESCRIPTION OF THE DRAWINGS

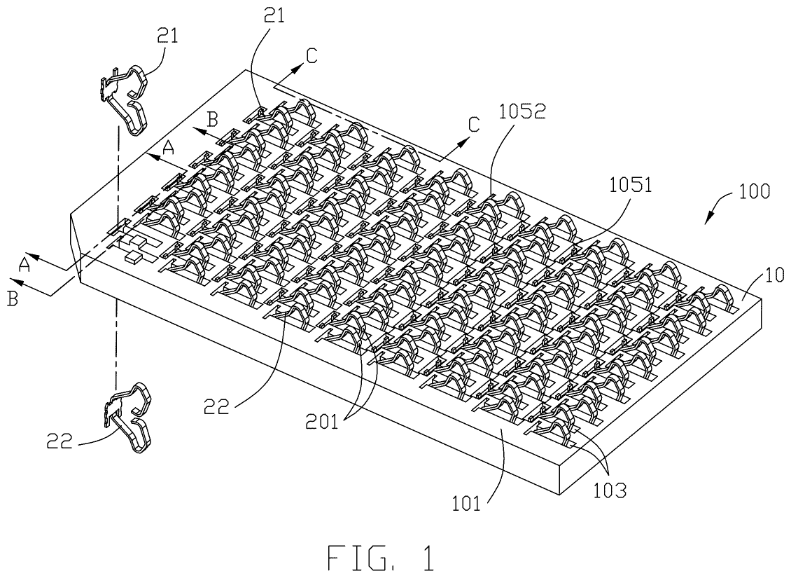

Referring to FIG. 1, a connector assembly 1000 has a circuit board, a cable, and a cap. The circuit board has a first contact portion made of a conductive material. The cable has a dielectric cladding and a signal wire. The signal wire has a first portion enclosed by the dielectric cladding, and a second portion extending out of the dielectric cladding. A free end of the second portion of the signal wire is connected to the first contact portion of the circuit board. Specifically, the signal wire is electrically connected to a circuit element of the circuit board, through the contact between the free end of the second portion of the signal wire and the first contact portion of the circuit board. The cap is arranged on the circuit board. The cap has a wall portion, a first beam portion, and at least two beam portions connecting the wall portion and the first beam portion. The wall portion of the cap has a first groove.

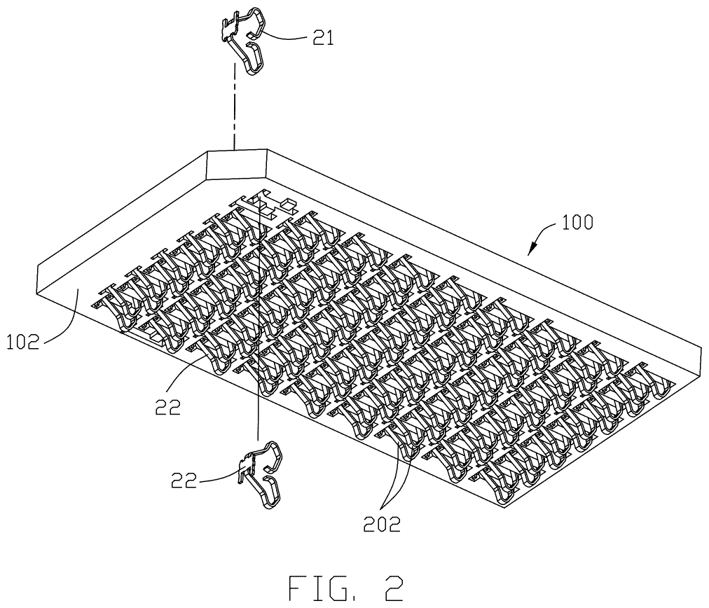

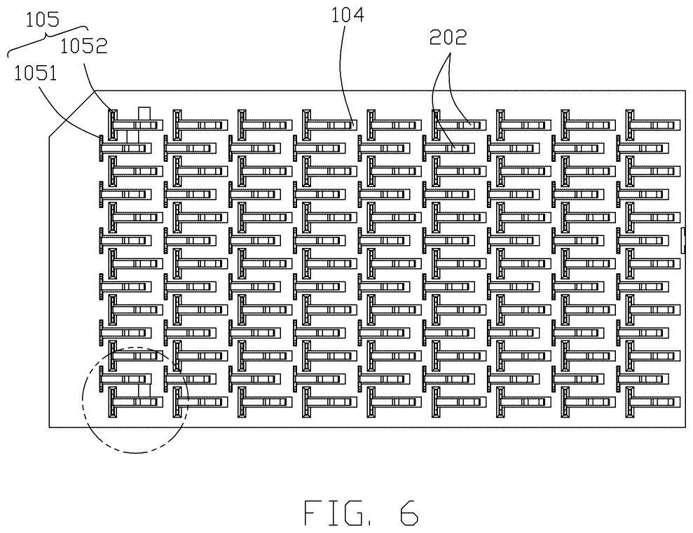

Referring to FIGS. 1-3, an electrical connector 100 of the present disclosure for electrically connecting a matching element (such as a chip module) to a circuit board, or connecting two circuit boards, includes an insulating housing 10 and a plurality of terminals 20. The insulating housing has a first face 101 and a second face 102 opposite each other, and a terminal slot 103 passing through the first surface 101 and the second surface 102. Each of the terminals 20 includes a base portion 200 fixed in the terminal slot, a first resilient arm 201 extending from the base portion 200 out of the first face 101, and a second resilient 202 arm extending from the base portion 200 out of the second surface 102. Referring to FIG. 6, the terminal slot 103 includes an accommodation slot 104 and a fixing slot 105 in fluid communication with the accommodation slot, the base portion 200 is fixed in the fixing slot 105, and the first resilient arm 201 and the second resilient arm 202 extend from the base portion 200, pass through the accommodation slot 104, and respectively protrude from the first face 101 and the second face 102. The electrical connector 100 includes at least a row of terminals 20 arranged along a first direction (front-rear direction in FIG. 1). The resilient arms of the terminals 20 extend forward in a second direction (left-right direction of FIG. 1) perpendicular to the first direction. The row of terminals 20 arranged along the first direction includes first terminals 21 and second terminals 22 which are alternately arranged. In the present embodiment, structures of the first terminals 21 and the second terminals 22 are similar. The second terminals 22 are the first terminals 21 turned upside down and inserted into the insulating housing 10. Namely, the base portion 200 of each of the first terminal 21 is inserted into the fixing slot 105 through the first face 101, the base portion 200 of each of the second terminals 22 is inserted into the fixing slot 105 through the second face 102. In the present disclosure, the terminals 20 arranged along the first direction are arranged in a plurality of rows, and the rows of terminals 20 are arranged side by side along the second direction, forming an array. Therefore, a plurality of first terminals 21 form a row along the second direction, a plurality of second terminals 22 form a row along the first direction, and the row of the first terminals 21 arranged along the second direction and the row of the second terminals 22 arranged along the second direction are alternately arranged along the first direction.

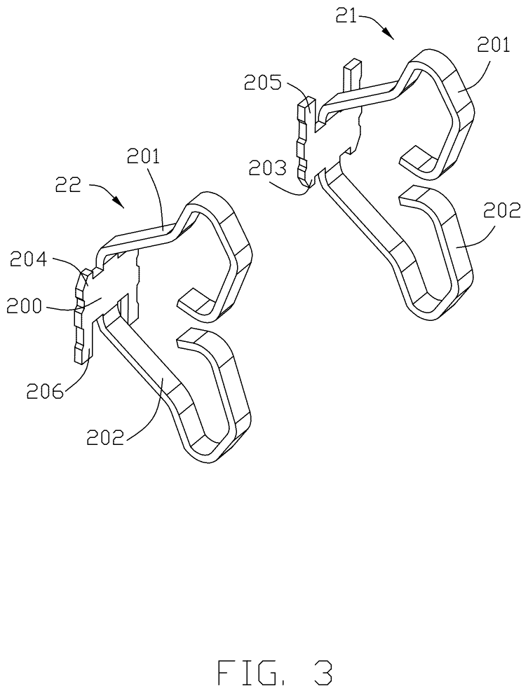

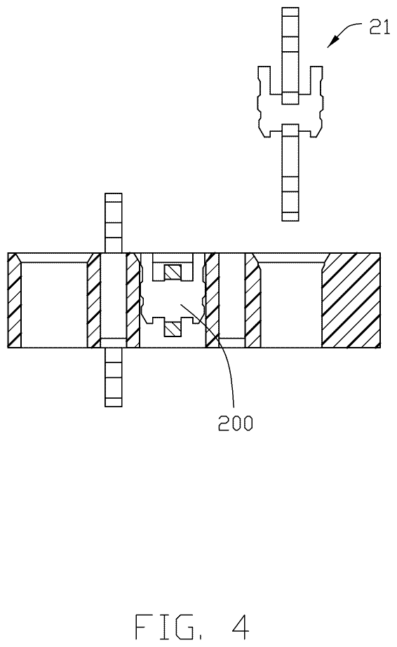

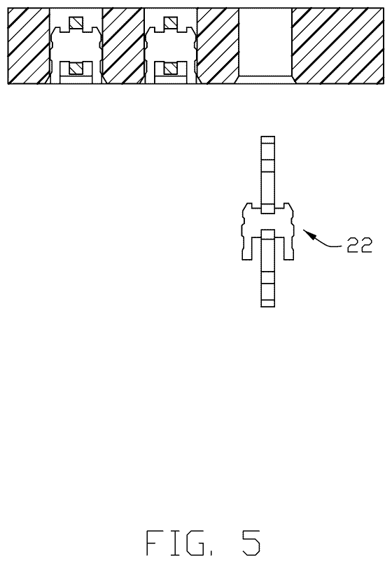

Referring to FIGS. 3-5, to facilitate installing the first terminals 21 and the second terminals 22 respectively through the first face 101 and the second face 102, and into the corresponding terminal slots 103, each of the terminals 20 has guide ribs extending from the base portion 200. The guide ribs 203 of each of the first terminals 21 extend from the base portion 200 toward the second face 102, and is positioned at two sides of the second resilient arm 202. The guide ribs 204 of each of the second terminals 22 extend from the base portion 200 toward the first face 101, and is positioned at two sides of the first resilient arm 201. Each of the terminals 20 further includes a strip connecting rib extending from the base portion 200. The strip connecting ribs extend in a direction from the base portion 200 away from the guide ribs 203. The strip connecting ribs 205 of the first terminal 21 extend from the base portion 200 toward the first face 101 and is positioned at two sides of the first resilient arm 201. The strip connecting ribs 206 of the second terminal 22 extend from the base portion 200 toward the second face 102 and is positioned at two sides of the second resilient arm 202. When installing the terminals 20, the first terminals 21 arranged along the first direction are connected to a strip by the strip connecting ribs 205 (not show in the figures), and then the strip is clamped by a tool for installing the first terminals 21 arranged along the first direction into the terminal slots 103 through the first face 101. The second terminals 22 arranged along the first direction are connected to another similar strip by the strip connecting ribs 206, and then the strip is clamped by a tool for installing the second terminals 22 arranged along the first direction into the terminal slots 103 through the second face 102. To facilitate connection between the terminals 20 and the strip, a length of the strip connecting ribs 205, 206 is long, and greater than a length of the guide ribs 203. Additionally, to facilitate installing and fixing the terminals 20 into the terminal slot 103, each of the guide ribs 203 has a guide face. Additionally, each of the base portions 200 and the strip connecting ribs 205, 206 has a hook at its outer edge for securely fixing the terminals 20 in the terminal slots 103.

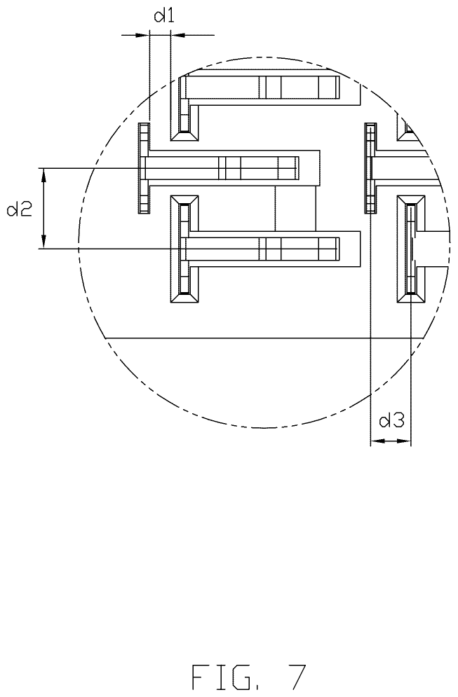

Referring to FIGS. 1 and 6, in the present embodiment, each of the fixing slots 105 is a elongated structure arranged along the first direction. The fixing slots 105 (referred below as first fixing slots 1051) accommodating the base portions 200 of the first terminals 21 along the first direction are arranged in a row. The fixing slots 105 (referred below as second fixing slots 1052) accommodating the base portions 200 of the second terminals 21 along the first direction are also arranged in a row. In order to arrange terminals in a tight space, in a row of the terminals 20 arranged in the first direction, each of the second terminals 22 are offset from the neighboring first terminals 21 in the second direction. Thus, the two neighboring rows of the first fixing slots 1051 and the second fixing slots 1052 each arranged along the first direction are offset from each other in the second direction. Referring to FIG. 7, the first fixing slot 1051 and the neighboring second fixing slot 1052 has a gap d1 therebetween in the second direction. The gap d1 is less than 0.16 millimeters. In some embodiments, the gap d1 is 0.13 millimeters. Additionally, looking in the second direction, each of the first fixing slots 1051 overlaps with left and right neighboring second fixing slots 1052. In the present embodiment, each of the first terminals 21 is a ground terminal, and each of the second terminals 22 is a signal terminal, and each of the second terminals 22 is offset forward relative to the first terminals 21 at the respective two sides thereof. Thus, The base portion of the second terminal 22 is positioned between the resilient arms of the neighboring first terminals at the two sides, and a front end of the second terminal 22 is positioned behind and clear of a row of terminals 20 in front of it. Namely, the second terminal 22 and the row of terminals 20 in front of it do not overlap along the second direction. The resilient arms of the second terminal 22 extend forward and is positioned entirely behind the base portion 200 of the row of the first terminals 21 in front, preventing signal interference between the two neighboring rows of terminals. It can be understood that, in other embodiments, the first terminals 21 can be configured as signal terminals, and the second terminals 22 can be configured as ground terminals. Referring to FIG. 7, in order to tightly arrange the terminals 20, in the present embodiment, in a row of the first terminals 21 and the second terminals 22 in the first direction, a gap d2 along the first direction between each of the first terminals 21 and the neighboring second terminal 22 is less than 0.8 millimeters, and a gap d3 along the second direction between each of the first terminals 21 and the neighboring second terminal 22 is less than 0.8 millimeters.

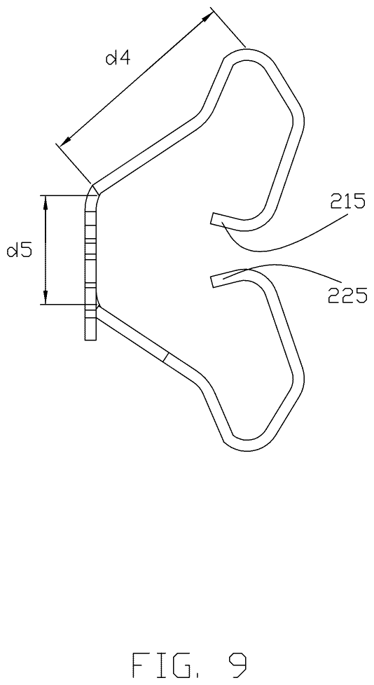

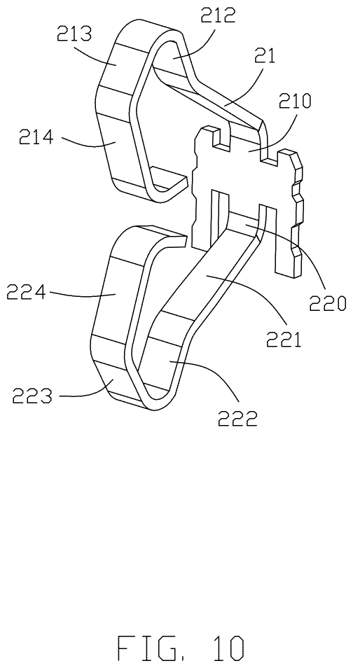

Referring to FIGS. 3 and 9-10, the first resilient arm 201 of the each of the terminals 20 includes in order an up vertical portion 210 extending from the base portion 200, a first up inclining portion 211, a second up inclining portion 212, a first down inclining portion 213, a second down inclining portion 214, and an up contact end 215. A curved up contact portion is formed between the second up inclining portion 212 and the first down inclining portion 213. The first down inclining portion 213 inclines downward and outward. The second down inclining portion 214 inclines downward and inward. The up contact end 215 bends inward from an end of the second down inclining portion 214. The second resilient arm 202 of the each of the terminals 20 includes in order a down vertical portion 220 extending from the base portion 200, a third down inclining portion 221, a fourth down inclining portion 222, a third up inclining portion 223, a fourth up inclining portion 224, and a down contact end 225. The down contact end 225 bends inward from an end of the fourth up inclining portion 224. In the present embodiment, the first resilient arm 201 and the second resilient arm 202 are symmetrically arranged along an up-down direction. When the first resilient arm 201 and the second resilient arm 202 are in a free state, the up contact end 215 and the down contact end 225 are separate from each other. When the first resilient arm 201 and the second resilient arm 202 are pressed and deformed, the up contact end 215 is driven by the first resilient arm 201 and moves downward, and the down contact end 225 is driven by the second resilient arm 202 and moves upward. Thus, the up contact end 215 and the down contact end 225 move closer to and contact each other. Referring to FIG. 9, in order to increase resilience of the terminals, a combined length d4 of the first up inclining portion 211 and the second up inclining portion 212 is greater than a length d5 from the up vertical portion 210 to the down vertical portion 220. In the present embodiment, the first resilient arm 201 and the second resilient arm 202 are arranged symmetrically in an up-down direction. Structures of the first terminal 21 and the second terminal 22 are the same. The only difference is that the first terminal 21 and the second terminal 22 are arranged in the insulating housing 10 in different directions, and are arranged up-side down relative to each other in the up-down direction in the insulating housing 10. In some embodiments, structures of the first terminal and the second terminal can be different, or generally the same, as long as they are arranged in different directions.

The above embodiments are preferred embodiments of the present invention, but not all possible embodiments. Any equivalent changes made to the technical solutions of the present invention by a person skilled in the art after reading the specification of the present invention are covered by the claims of the present invention.

1. An electrical connector comprising:
an insulating housing having a first face and a second face opposite each other, and a plurality of accommodation slots and a plurality of fixing slots in fluid communication with the accommodating slots passing through the first face and the second face; and
at least one row of terminals arranged in a first direction and extending forward along a second direction perpendicular to the first direction, each terminal comprising:
a base portion fixed in one of the fixing slots;
a first resilient arm extending from the base portion, passing through a corresponding accommodation slot, and protruding from the first face; and
a second resilient arm extending from the base portion, passing through a corresponding accommodation slot, and protruding from the second face; wherein
the at least one row of terminals comprises first terminals and second terminals alternately arranged, the base portions of the first terminals are inserted from the first face into corresponding fixing slots, and the base portions of the second terminals are inserted from the second face into corresponding fixing slots.

2. The electrical connector according to claim 1, wherein each of the terminals has a pair of strip connecting ribs extending from the base portion and a pair of guide ribs extending from the base portion, a length of the strip connecting ribs is greater than a length of the guide ribs, the strip connecting ribs of each of the first terminals extend from the base portion toward the first face and are positioned at two sides of the first resilient arm, the guide ribs of each of the first terminals extend from the base portion toward the second face and are positioned at two sides of the second resilient arm, the strip connecting ribs of each of the second terminals extend from the base portion toward the second face and are positioned at two sides of the second resilient arm, and the guide ribs of each of the second terminals extend from the base portion toward the first face and are positioned at two sides of the first resilient arm.

3. The electrical connector according to claim 2, wherein an outer edge of each of the base portions and an outer edge of each of the strip connecting ribs each have a respective hook.

4. The electrical connector according to claim 1, wherein the fixing slots comprise first fixing slots for accommodating the base portions of the first terminals and second fixing slots for accommodating the base portions of the second terminals; the first terminals and the second terminals are elongated structures extending along the first direction; viewing in the first direction the first fixing slots are arranged in a row, the second fixing slots are arranged in a row, and the first fixing slots and the second fixing slots are offset from each other along the second direction; and viewing in the second direction, the first fixing slots and the second fixing slots overlap.

5. The electrical connector according to claim 4, wherein the first resilient arms and the second resilient arms each have a curved contact portion, and a gap along the second direction between one of the first fixing slots and a neighboring second fixing slot is less than 0.16 millimeters.

6. The electrical connector according to claim 4, wherein the first terminals are ground terminals aligned and arranged along the second direction, the second terminals are signal terminals aligned and arranged along the second direction, and the terminals form an array.

7. The electrical connector according to claim 6, wherein each of the signal terminals is offset forward along the second direction relative to the ground terminals at two sides thereof, and the base portion of the signal terminal is positioned between the resilient arms of neighboring ground terminals.

8. The electrical connector according to claim 7, wherein along the second direction, the resilient arms of each of the signal terminals are positioned behind the base portion of the ground terminal in the neighboring row in front of the signal terminal.

9. The electrical connector according to claim 1, wherein neighboring first terminals and second terminals arranged in a row of terminals along the first direction are offset from each other along the second direction, and a gap along the first direction between two of the neighboring terminals and a gap along the second direction between two of the neighboring terminals are each less than 0.8 millimeters.

10. An electrical connector comprising:
an insulating housing having a first face, an opposite second face, and terminal slots passing through the first face and the second face; and
a plurality of terminals arranged in an array and comprising one row of ground terminals and one row of signal terminals; wherein
the signal terminals and the ground terminals are alternately arranged along the first direction, each of the terminals comprises a base portion fixed in one of the terminal slots, a first resilient arm extending from the base portion and out of the first face, a second resilient arm extending from the base portion and out of the second face, and guide ribs extending from the base portion for facilitating installation of the terminal, the guide ribs of each of the signal terminals extend from the base portion toward the first face and are positioned at two sides of the first resilient arm, the guide ribs of each of the ground terminals extend from the base portion toward the second face and are positioned at two sides of the second resilient arm, and the signal terminal and the ground terminal are installed to the insulating housing through the first face and the second face.

11. The electrical connector according to claim 10, wherein the signal terminals and the ground terminals are offset along a second direction along which the resilient arms extend, and when viewing in the second direction, the base portions of the signal terminals and the base portions of neighboring ground terminals overlap along the first direction.
